(19) United States
(12) Patent Application Publication
(10) Pub. No.: US 2026/0260127 A1
(43) Pub. Date: Sep. 3, 2026

(54) Conditional Adapter Models for Parameter-Efficient Transfer Learning with Fast Inference

(71) Applicant: Google LLC, Mountain View, CA (US)

(72) Inventors: Tao Lei, Sunnyvale, CA (US); Junwen Bai, Sunnyvale, CA (US); Siddhartha Brahma, San Jose, CA (US); Yuzhe Zhao, San Francisco, CA (US); Joshua Timothy Ainslie, Brentwood, TN (US); Ming-Wei Chang, Redmond, WA (US); Yu Zhang, Mountain View, CA (US); Yanqi Zhou, Hillsborough, CA (US); Nan Du, San Jose, CA (US); Yuexin Wu, Kirkland, WA (US); Bo Li, Santa Clara, CA (US); Kenton Chiu Tsun Lee, Kirkland, WA (US)

(21) Appl. No.: 19/474,515

(22) PCT Filed: Apr. 10, 2024
(86) PCT No.: PCT/US2024/023833

§ 371 Date: Oct. 10, 2025

Related U.S. Application Data
(60) Provisional application No. 63/495,214, filed on Apr. 10, 2023.

(51) Int. Cl. G06N 3/096; G06N 3/0499; G06N 3/082

(52) U.S. Cl. CPC G06N 3/096; G06N 3/0499; G06N 3/082

(57) ABSTRACT

Provided is a parameter-efficient transfer learning method that gains both parameter and inference efficiency. These approaches can in some cases be referred to as conditional adapter (CODA) and example models adapted in the proposed manner can be referred to as CODA models.

### RELATED APPLICATIONS

This application claims priority to and the benefit of U.S. Provisional Patent Application No. 63/495,214, filed Apr. 10, 2023. U.S. Provisional Patent Application No. 63/495,214 is hereby incorporated by reference in its entirety.

### FIELD

The present disclosure relates generally to machine learning. More particularly, the present disclosure relates to conditional adapter models that enable parameter-efficient transfer learning with fast inference.

### BACKGROUND

Large pretrained machine learning models have achieved groundbreaking results in various domains. However, one impediment to deploy them in real-world applications has been the cost of adaptation and inference. Due to the ever growing size of the pretrained models, for example, finetuning has become increasingly expensive as it requires a separate copy of the full model and updates to all parameters for every downstream task.

Parameter-efficient transfer learning such as Adapter (Houlsby et al., 2019) and Prompt tuning (Lester et al., 2021) have been proposed as attempts to address this issue. These methods only update a small subset of parameters for each downstream task, allowing the model to retain knowledge and avoid catastrophic forget-ting (Vu et al., 2022). Noticeably, these methods can match the accuracy of a fully finetuned model, while achieving better accuracy on out-of-domain data distributions (Lester et al., 2021; Awadalla et al., 2022).

Unfortunately, standard parameter-efficient transfer learning methods only bring parameter efficiency during the finetuning process, but do not have similar benefits at inference time. For example, while only a few small projection matrices are added into the pretrained model in the Adapter approach, all the model inputs (such as tokens) still use full parameters during inference. Therefore, the inference speed of the Adapter approach is the same (or slightly lower) with respect to the full finetuning methods.

Moreover, prior studies have shown that the parameter-efficient learning methods are most effective when the size of the pretrained model is large, making many advantages of these methods difficult to realize in practice.

### SUMMARY

Aspects and advantages of embodiments of the present disclosure will be set forth in part in the following description, or can be learned from the description, or can be learned through practice of the embodiments.

One example aspect of the present disclosure is directed to a computer system with improved inference efficiency. The computer system includes one or more processors and one or more non-transitory computer-readable media. The non-transitory computer-readable media collectively store: a machine-learned conditional adapter model configured to receive and process a model input to generate a model output. The machine-learned conditional adapter model includes one or more layers. At least a first layer of the one or more layers includes: a conditional processing branch; an adapter processing branch in parallel to the conditional processing branch; and a router sublayer comprising a plurality of learned parameter values. The router sublayer is configured to: apply the plurality of learned parameter values to a plurality of input tokens of the first layer to generate a plurality of routing values respectively for the plurality of input tokens; and select a subset of the plurality of input tokens for processing with the conditional processing branch based on the plurality of routing values. The computer-readable media store instructions that, when executed by the one or more processors, cause the computer system to use the machine-learned conditional adapter model to process the model input to generate the model output.

Another example aspect of the present disclosure is directed to a computer-implemented method to perform parameter-efficient transfer learning with fast inference. The method includes obtaining, by a computing system comprising one or more computing devices, a pre-trained machine-learned model having a plurality of layers. The method includes modifying, by the computing system, at least a first layer of the plurality of layers to add: an adapter processing branch in parallel to an existing processing branch of the first layer; and a router sublayer comprising a plurality of parameter values. The router sublayer is configured to: apply the plurality of parameter values to a plurality of input tokens of the first layer to generate a plurality of routing values respectively for the plurality of input tokens; and select a subset of the plurality of input tokens for processing with the existing processing branch based on the plurality of routing values. The method includes training, by the computing system, the machine-learned model to learn at least the plurality of parameter values of the router sublayer.

Another example aspect of the present disclosure is directed to one or more or more non-transitory computer-readable media that collectively store: a machine-learned conditional adapter model configured to receive and process a model input to generate a model output, wherein the machine-learned conditional adapter model comprises one or more layers, and wherein at least a first layer of the one or more layers comprises: a conditional processing branch; an adapter processing branch in parallel to the conditional processing branch; and a router sublayer comprising a plurality of learned parameter values, wherein the router sublayer is configured to: apply the plurality of learned parameter values to a plurality of input tokens of the first layer to generate a plurality of routing values respectively for the plurality of input tokens; and select a subset of the plurality of input tokens for processing with the conditional processing branch based on the plurality of routing values.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

The attached Appendix, which is fully incorporated into and forms a portion of this disclosure, describes example implementations of the systems and methods described herein. The present disclosure is not limited to the example implementations described in the attached Appendix.

### BRIEF DESCRIPTION OF THE DRAWINGS

Detailed discussion of embodiments directed to one of ordinary skill in the art is set forth in the specification, which makes reference to the appended figures, in which:

FIG. 1 illustrates a block diagram of an example process to generate an example conditional adapter model according to example embodiments of the present disclosure.

FIG. 2 illustrates a block diagram of an example process for training a conditional adapter model according to example embodiments of the present disclosure.

FIG. 3A depicts a block diagram of an example computing system according to example embodiments of the present disclosure.

FIG. 3B depicts a block diagram of an example computing device according to example embodiments of the present disclosure.

FIG. 3C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to parameter-efficient transfer learning techniques that also improve inference efficiency. The proposed techniques generalize beyond standard adapter approaches to enable a new way of balancing speed and accuracy using conditional computation. In particular, starting with an existing dense pretrained model, some example implementations of the present disclosure add sparse activation together with a small number of new parameters and a light-weight training phase. Example experiments demonstrate that the proposed approach provides an unexpectedly efficient way to transfer knowledge. Across a variety of language, vision, and speech tasks, the proposed approach achieves a 2× to 8× inference speed-up compared to the state-of-the-art Adapter approach (He et al., 2021) with moderate to no accuracy loss and the same parameter efficiency.

More particularly, the present disclosure proposes a parameter-efficient transfer learning method that gains both parameter and inference efficiency. Example implementations of the proposed methods can be referred to as conditional adapter (CODA) and example models adapted in the proposed manner can be referred to as CODA models. The proposed approach is a generalization of the Adapter approach, with the following intuition—a machine learning system can treat the pretrained model as a universal source of knowledge but only query against it for necessary inputs.

Specifically, similar to standard Adapter approaches, a machine learning model can be adapted to include a small adapter branch in one or more of its layers. The parameter(s) of these adapter branch(es) can be updated while leveraging and fixing the pre-trained Transformer block for downstream adaptation. However, unlike previous approaches, the proposed techniques assume that many of the token representations in each layer are less important for the downstream task and therefore not require heavy computation. In such cases, the pretrained Transformer block can be skipped. Given that the adapter branch has very few parameters and is much faster compared to the original Transformer blocks, a model adapted as described herein runs significantly faster than the standard adapter approach.

While conditionally activating the expensive branches has clear speed benefits, CODA models must learn to select important tokens for heavy computation in order to maintain model accuracy. To this end, some example CODA models can include a soft top-k router which can be seen as a generalization of softmax and a relaxation of hard top-k. The present disclosure also provides a fast and differentiable algorithm to compute the token selection decision. This selection is embedded as an integral part of the model computation and as a result can be directly optimized for downstream performance, without the need of additional regularization loss.

Example experiments evaluated example CODA models on three different domains—natural language processing, computer vision and speech processing. Overall, the example CODA models achieved 2 to 8 times inference speed-up over the standard adapter approach with moderate to no accuracy loss. Further, the example experiments demonstrated that with just a little to no router pretraining, existing dense pretrained models such as T5 (Raffel et al., 2020) can be efficiently converted into CODA models to gain both parameter efficiency and speed advantages.

The present disclosure provides a number of technical effects and benefits. As one example, the proposed approach enables a large machine learning model to have improved inference efficiency. In particular, the proposed techniques can include modifying a large model (e.g., a transformer) to have an adapter branch in parallel with a conditional branch. The adapter branch may have fewer parameters than the conditional branch and therefore require less computational expenditure to compute. A routing layer can route some (e.g., but not all) of a set of input tokens to the conditional branch. In this manner the computational expenditure required to process an input can be reduced. For example, the number of computational operations overall can be reduced compared to running the full model. Performing fewer computational operations corresponds to conservation of computational resources such as reduced processor cycles, reduced memory usage, and/or reduced network bandwidth. Thus, the proposed approach corresponds to an improvement in the functioning of a computer itself.

With reference now to the Figures, example embodiments of the present disclosure will be discussed in further detail.

### Example Conditional Adapter Models

### Overview of Example Conditional Adapter Model Process and Architecture

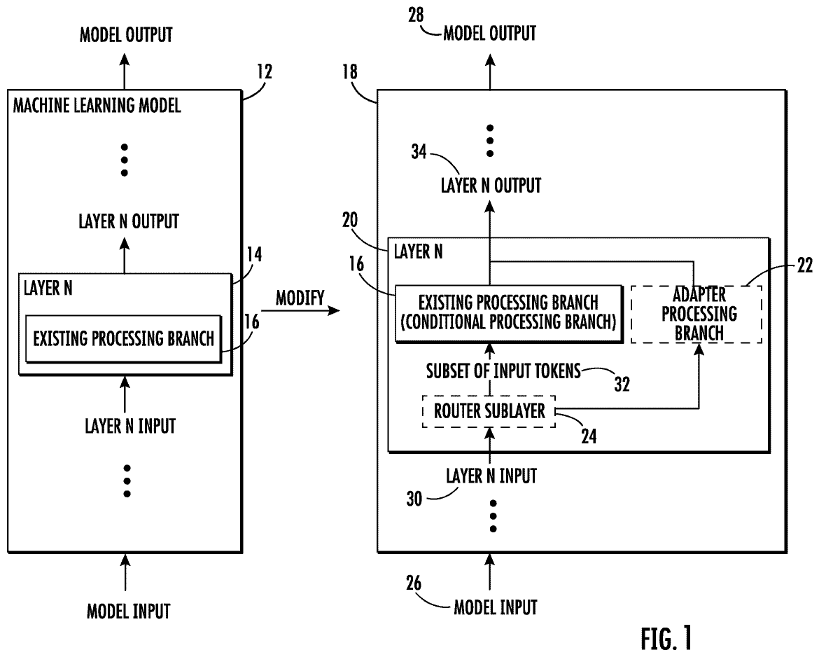

FIG. 1 illustrates a block diagram of an example process to generate an example conditional adapter model. The process can include obtaining a pre-trained machine-learned model 12 having a plurality of layers. For example, the pre-trained machine-learned model 12 is shown as having an N-th Layer 14 that includes an existing processing branch 16. Although one layer 14 is shown, the model 12 can include any number of such layers.

The process for generating the conditional adapter model can include modifying the pre-trained machine-learned model 12 to generate a conditional adapter model 18. In particular, the layer 14 of the pre-trained machine-learned model 12 can be modified to include an adapter processing branch 22 in parallel to the existing processing branch 16 (which can now be referred to as a conditional processing branch 16). The modified layer is shown as layer 20. The layer 20 can also include a router sublayer 24. Although one layer 20 is shown, the model 18 can include any number of layers. Some or all of such layers can have the configuration shown for layer 20.

The machine-learned conditional adapter model 18 can be configured to receive and process a model input 26 to generate a model output 28. The machine-learned conditional adapter model 18 can include one or more layers (e.g., N layers). Some or all of the layers may have the structure shown in FIG. 1.

In particular, as illustrated in FIG. 1, the N-th layer 20 of the conditional adapter model 18 can include: the conditional processing branch 16, the adapter processing branch 22 in parallel to the conditional processing branch 16, and the router sublayer 24.

The router sublayer 24 can include a plurality of learned parameter values. The router sublayer 24 can be configured to: apply the plurality of learned parameter values to a plurality of input tokens 30 of the layer 20 to generate a plurality of routing values respectively for the plurality of input tokens 30. The router sublayer 24 can be configured to select a subset 32 of the plurality of input tokens 30 for processing with the conditional processing branch 16 based on the plurality of routing values. In some implementations, the adapter processing branch 22 can be configured to process all of the plurality of input tokens 30.

In some implementations, the conditional processing branch 16 can include a second plurality of parameter values that have been pre-trained at a pre-training stage performed prior to the addition of the adapter processing branch 22 and the router sublayer 24 to the layer 20. In some implementations, the adapter processing branch 22 can include a third plurality of parameter values that have been learned in one or more additional training stages following the pre-training stage. For example, during the one or more additional training stages the second plurality of parameter values of the conditional processing branch 16 can have been held fixed.

In some implementations, a first number of floating point operations associated with processing of all of the input tokens 30 with the conditional processing branch 16 is greater than a second number of floating point operations associated with processing of all of the input tokens 30 with the adapter processing branch 22.

In some implementations, the conditional processing branch 16 can be or include a transformer layer and the adapter processing branch 22 can be or include a feed-forward layer. However, the conditional processing branch 16 is not limited to transformer layers and may be other forms or architectures of layers or branches that would be able to perform conditional computation on the selected subset 32 of tokens.

In some implementations, the router sublayer 24 is configured to select a top-k number of the input tokens 30 as the subset 32 for processing with the conditional processing branch 16 based on the plurality of routing values generated by the router sublayer 24. In some implementations, the plurality of routing values can be or include a one-hot vector of binary values.

In some implementations, the router sublayer 24 is configured to: apply the plurality of learned parameter values to the plurality of input tokens 30 of the layer 20 to generate a plurality of selection weights respectively for the plurality of input tokens. The router sublayer 24 can determine the plurality of routing values for the plurality of input tokens 30 based on the plurality of selection weights.

In some implementations, the router sublayer 24 is further configured to generate a set of masked tokens based on the plurality of routing values, wherein tokens that are not included in the subset are masked to have a value of zero. The router sublayer 24 can project the set of masked tokens into a reduced shape that does not include zero-valued tokens.

In some implementations, the conditional processing layer 16 is configured to perform k-to-k attention in which the set of masked tokens are used as both query vectors and key-value vectors.

In some implementations, the conditional processing layer 16 is configured to perform k-to-all attention in which the set of masked tokens are used as query vectors and all of the input tokens are used as key-value vectors.

In some implementations, the layer 20 is configured to generate a layer output 34 that comprises the plurality of input tokens 30 summed with an output of the adapter processing branch 22 summed with an output of the conditional processing branch 16 that has been scaled according to the plurality of selection weights.

In some implementations, to determine the plurality of routing values for the plurality of input tokens 30 based on the plurality of selection weights, the router sublayer 24 is configured to perform a soft top-k operator on the plurality of selection weights.

In some implementations, the model input 26 comprises a natural language input and the model output 28 comprises an output for a natural language processing task.

In some implementations, the model input 26 comprises an image input and the model output 28 comprises an output for an image processing task.

In some implementations, the model input 26 comprises a speech input and the model output 28 comprises an output for a speech processing task.

Having given an overview of example implementations of a conditional adapter model, further example details will be provided. Some or all of these details may be used to generate the example conditional adapter models.

### Example Notation

Use F( ) to denote a parameterized neural network and the corresponding function defined by the network. For instance, a Transformer layer consists of an attention sub-layer Fₐₜₜ( ) followed by a feed forward sub-layer F_{ffn}( ). Each layer also employs layer normalization, namely LNₐₜₜ ( ) and LN_{ffn}( ), before applying the attention and feed forward functions.

Specifically, let X^{l}∈ [symbol] ^{n×d} be the layer input of the l-th Transformer encoder layer, where n is the number of tokens in the input sequence and d is the hidden size of the model. The input to the next layer X^{l+1} is computed as follows:

$$\begin{matrix}{\overline{X}}^{l} = {X}^{l} + {F}_{att} ( L {N}_{att} ( {X}^{l} ) ) \\ {X}^{l + 1} = {\overline{X}}^{l} + {F}_{ffn} ( L {N}_{ffn} ( {\overline{X}}^{l} ) )\end{matrix} \qquad ( 1 )$$

The parameters associated with these functions in each layer can be pretrained following the common practices such as T5 (Raffel et al. (2020)).

### Example Architecture

Some example implementations of the present disclosure can add parallel adapter branches that introduce only a small number of learnable parameters for a given downstream task, while the vast majority of model parameters (e.g., associated with the pretrained Transformer) remain fixed. Unlike previous adapter methods where all the input tokens are processed by the pretrained Transformer layers, some example implementations only send k=┌n/r┐ tokens for heavy processing by the existing conditional layer. As one example, define r>1 as the reduction factor, a constant (e.g., such as 5) to control the inference speed-up.

Whenever it is clear from the context, this description drops the superscript l in the notations. All the input and intermediate matrices are defined and computed within the scope of the l-th layer.

Given layer input X, some example models can first apply layer normalization, namely \tilde{X}=LNₐₜₜ(X). The normalized input will be processed by the adapter branch and the conditional Transformer branch. Their outputs are then added and combined as the final output of the layer.

Example Adapter: Let F_{adapter}( ) denote the transformation function of the adapter module. The output of the adapter can be defined as

$$Y = {F}_{adapter} ( \tilde{X} ) \qquad ( 2 )$$

In some example implementations, F_{adapter}( ) is a feed forward network with a small intermediate hidden size such as, for example, 64. As a result, computing Y only adds a small number of floating point operations and its cost is often negligible compared to the cost of the heavy Transformer branch. In some implementations, the adapter branch does not conditionally select tokens. Instead, in some implementations, F_{adapter}( ) is applied to all input tokens X∈ [symbol] ^{n×d}.

Example Conditional Branch: In some implementations, the computation of the conditional branch takes three steps. First, each conditionally-adapted layer defines a router function Fᵣₒᵤₜₑᵣ( ) to select k tokens for the conditional branch. The router function in each layer returns two outputs

$$m , P = {F}_{router} ( \tilde{X} ) \qquad ( 3 )$$

where P∈{0,1}^{k×n} is a matrix consisting of k one-hot vectors indicating the selection of tokens. Here P[i,j]=1 if and only if the i-th selected token is the j-th input token from \tilde{X}. m∈[0,1]ⁿ is a weight mask in which m[j] is the selection weight for the j-th input token. m[j]=0 if the token is not selected.

After the routing decision is made, the input hidden representations of the selected tokens can be collected using a matrix multiplication,

$$\hat{X} = P \tilde{X} ∈ {ℝ}^{k \times d} \qquad ( 4 )$$

where a subset of k rows in \tilde{X} is selected to construct the k-by-d matrix \hat{X}. Similar to a standard Transformer layer, the conditional branch applies the attention and feed forward transformations to the selected input:

$$\hat{Z} = {F}_{att} ( \hat{X} ) \qquad ( 5 )$$

$$\overline{Z} = {F}_{ffn} ( {LN}_{ffn} ( \hat{X} + \hat{Z} ) ) \qquad ( 6 )$$

where \hat{Z}, Z̅∈ [symbol] ^{k×d} denote the output of the attention network and the feed forward network respectively. Note that some example implementations do not apply normalization over \hat{X} because it has already been normalized.

A number of different attention variants can be used. Two example variants are described in this section which differ in how they use \hat{X}. One example variant applies a k-to-k attention using \hat{X} as both the query vectors and key-value vectors. Another example variant applies a k-to-all attention using all the input tokens (i.e. \tilde{X}) as the attention keys and values. This variant runs slower but retains higher quality close to the full model.

In the last step, \hat{Z} and Z̅ can be combined and projected back to the same shape of the original input

$$Z = {P}^{T} ( \hat{Z} + \overline{Z} ) ∈ {ℝ}^{n \times d} \qquad ( 7 )$$

Then Z merges with the adapter output and the original input of the current layer to produce the final output:

$${X}^{l + 1} = X + Y + m ⊙ Z \qquad ( 8 )$$

m⊙Z is an element-wise multiplication that scales the rows of Z using weight m. This operation can be seen as a gating operation, where the hidden state Z[i] of the i-th token is weighted by the selection score m[i] assigned by the router. This enables the gradient propagation from m to the router parameters, such that the token selection can be jointly optimized with other model components during training.

### Example Learned Router Sublayer

One example aspect of CODA is the router function Fᵣₒᵤₜₑᵣ( ) that can be optimized to select a subset of tokens for favorable model performance. Given the n input tokens \tilde{X}, one example router first computes dot-product score s∈ [symbol] ⁿ:

$$s = \tilde{X} w \qquad ( 9 )$$

where w∈ [symbol] ^{d} is a parameter vector associated with the router in this layer. The dot-product score s can be further normalized by a function ƒ( ): [symbol] ^{d}→[0,1]^{d}, and clipped to produce the selection score m:

$$λ = f ( s ) \qquad ( 10 )$$

$$m = λ ⊙ Top ( λ , k ) ∈ {ℝ}^{n} \qquad ( 11 )$$

Here Top(λ, k)∈{0,1}ⁿ is an indicator function so that the returned vector has 1 in the i-th entry if λ[i] is among the top-k values. The one-hot matrix P defined in (3) can be created according to Top(λ, k). Generally speaking, the tokens with the highest scores will be selected by the router.

In some implementations, function ƒ( ) remains differentiable with respect to its input (s in this case) such that the router parameters w can be updated during training. One possible choice for ƒ( ) is the sigmoid activation function which normalizes the values in s independently. However, this does not explicitly model the constraint of selecting k tokens from the available n tokens. Consider a simple case where k=1, a natural choice for ƒ( ) would be the softmax function. Since softmax provides global normalization over the input scores, a gradient update to increase one of the scores would also decrease the other scores, a desirable effect for learning top-1 selection.

In another example, a soft top-k operator that generalizes softmax can be used for general k>1. This is indeed possible by formalizing soft top-k as the following optimization problem:

$$\begin{matrix}f ( s ) := {argmax}_{λ} {s}^{T} λ + ε H ( λ ) \\ s . t . {1}^{T} λ = k , λ [ i ] ∈ [ 0 , 1 ] ∀ i = 1 , … , n\end{matrix} \qquad ( 12 )$$

Here

$$H ( λ ) = {\sum }_{i = 1}^{n} - λ [ i ] log λ [ i ]$$

is a generalized entropy function (applied to any positive vector λ instead of a distribution), and ε>0 is a small coefficient.

This optimization problem is closely related to the softmax and top-k operation. Specifically, when ε=0, it becomes a linear program which returns Top(s, k) as the solution. In addition, when k=1, it can be shown that its solution is softmax(s/ε). Broadly speaking, (12) will return a soft top-k mask and the smoothness is controlled by ε.

Problem (12) does not have a closed-form solution for an arbitrary ε>0 and k>1, but its solution can be obtained using an iterative algorithm. Specifically, let a∈ [symbol] and b∈ [symbol] ⁿ be two auxiliary variables (e.g., which can be initialized to zeros). The solution takes the form

$$λ = exp ( \frac{s + b + a}{ε} ) .$$

The values of a and b can be obtained using the following iterative updates:

$$\begin{matrix}{a}^{′} = εln ( k ) - εln ( {\sum }_{i = 1}^{n} exp ( \frac{s [ i ] + b [ i ]}{ε} ) ) \\ {b}^{′} = min ( - s - {a}^{′} , 0 )\end{matrix} \qquad ( 13 )$$

To provide one example possibility the following settings can be used, T=20 iterations and the function ƒ(s) returns

$$exp ( \frac{s + b + a}{ε} )$$

using a and b from the last iteration. The function ƒ(s) remain differentiable with respect to s using these iterative updates, so that the router can be trained jointly with other model parameters.

### Example Training

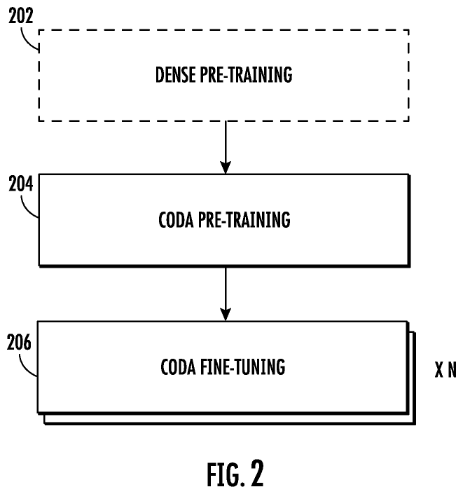

FIG. 2 illustrates a block diagram of an example process for training a conditional adapter (CODA) model according to example embodiments of the present disclosure. As shown in FIG. 2, a model can first be subjected to dense pre-training at step 202. Then, the model can be adapted to be a CODA model, such as was shown and discussed with reference to FIG. 1. The CODA model can be pre-trained on a pre-training task and/or dataset at 204. The CODA model can then be fine-tuned on a fine-tuning task and/or dataset at 206 (e.g., for N fine-tuning iterations).

FIG. 2 shows the dense pre-training at 202 for the purpose of generally explaining an example approach. However, rather than performing dense pre-training specifically on or for a CODA model, a CODA model can instead be directly initialized from an existing model. This includes pretrained language models such as Transformer models (e.g., T5 and BERT), and similar architectures used for other modalities. Converting an existing Transformer model into a CODA model can be done as follows: the Transformer layers can be directly re-used and copied in the conditional branch of the CODA model. Then, the adapter and router networks can be added and randomly initialized. Because pretraining a large dense model can be expensive, adapting pre-trained models as described above can reduce the overall training cost.

The routers and neural network components in a CODA model can be jointly optimized to improve the accuracy of the model predictions. A random initialization of the router (and adapter) parameters can be sub-optimal, when the available finetuning data is limited. Therefore, in some implementations, a CODA model can be further pretrained using the same pretraining objective as the dense model, in order to obtain better downstream performance. Importantly, a CODA model requires significantly fewer training steps during pretraining, since most of its parameters are taken from an already pretrained model. Therefore, training a CODA model consumes fewer computational resources. In particular, the computational cost of pretraining a CODA model can be 10-30× lower than the pretraining of its original dense model.

After pre-training, the CODA model can be fine-tuned on downstream tasks by only updating the adapter, router and layer normalization parameters. Since each router only introduces d parameters (e.g., w∈ [symbol] ^{d}), the CODA model remains parameter-efficient similar to other adapter and prompt-tuning methods.

### Example Devices and Systems

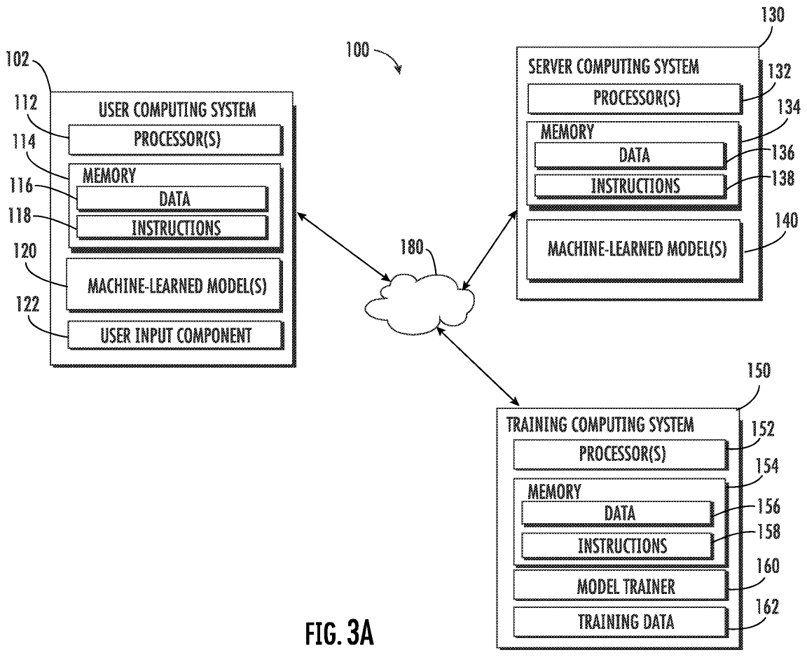

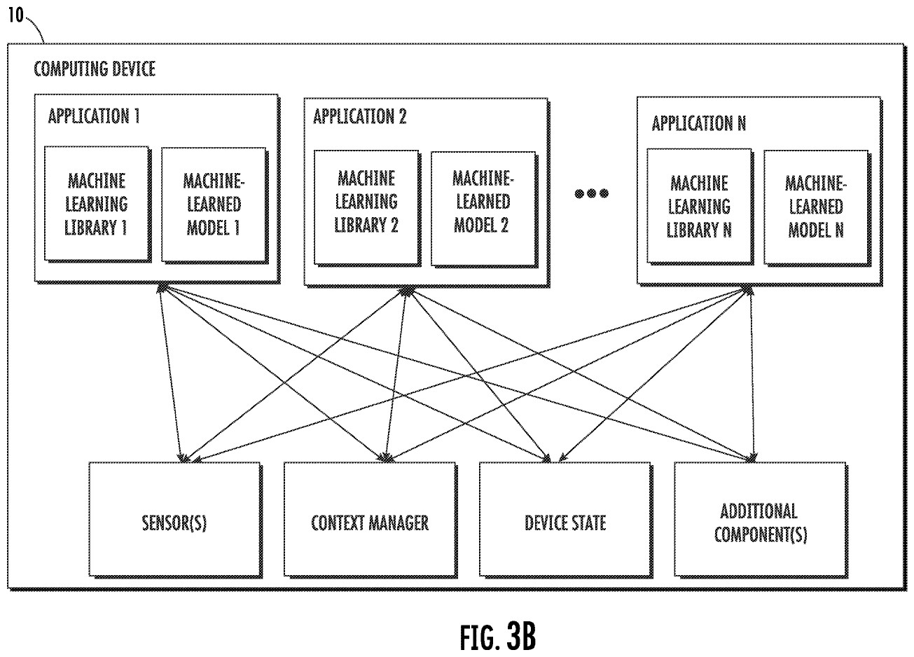

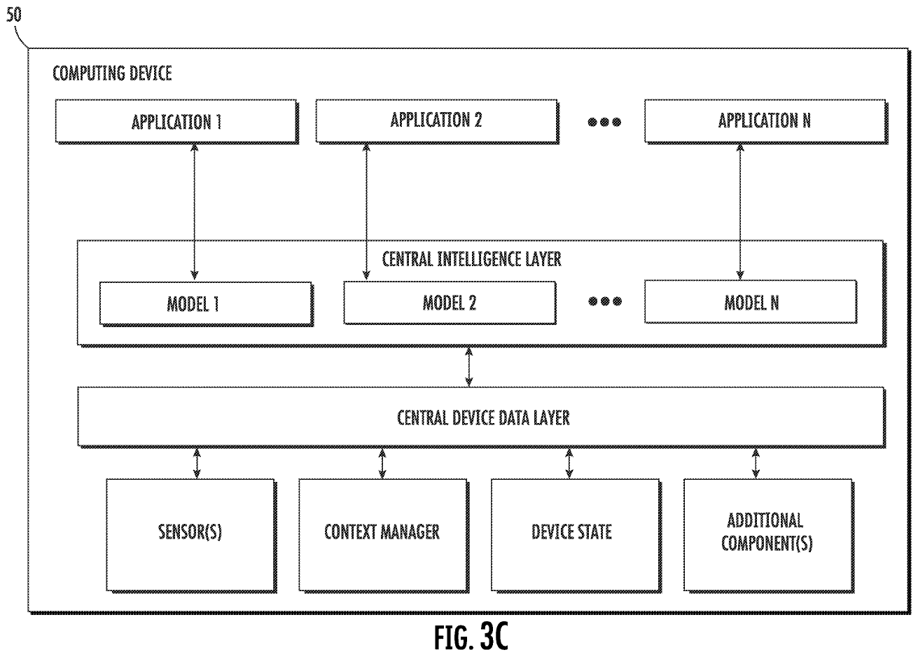

FIG. 3A depicts a block diagram of an example computing system 100 that according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIG. 1.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIG. 1.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media. The model trainer 160 can perform any of the adaption operations illustrated in FIG. 1 or otherwise discussed herein (e.g., to adapt a pre-trained model to be a CODA model). The model trainer 160 can perform any of the training operations illustrated in FIG. 2.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer system with improved inference efficiency, the computer system comprising:
one or more processors; and
one or more non-transitory computer-readable media that collectively store:
a machine-learned conditional adapter model configured to receive and process a model input to generate a model output, wherein the machine-learned conditional adapter model comprises one or more layers, and wherein at least a first layer of the one or more layers comprises:
a conditional processing branch;
an adapter processing branch in parallel to the conditional processing branch; and
a router sublayer comprising a plurality of learned parameter values, wherein the router sublayer is configured to:
apply the plurality of learned parameter values to a plurality of input tokens of the first layer to generate a plurality of routing values respectively for the plurality of input tokens; and
select a subset of the plurality of input tokens for processing with the conditional processing branch based on the plurality of routing values; and
instructions that, when executed by the one or more processors, cause the computer system to use the machine-learned conditional adapter model to process the model input to generate the model output.

2. The computer system of claim 1, wherein the adapter processing branch is configured to process all of the plurality of input tokens.

3. The computer system of claim 1, wherein the conditional processing branch comprises a second plurality of parameter values that have been pre-trained at a pre-training stage performed prior to an addition of the adapter processing branch and the router sublayer to the first layer.

4. The computer system of claim 3, wherein the adapter processing branch comprises a third plurality of parameter values that have been learned in one or more additional training stages following the pre-training stage, wherein during the one or more additional training stages the second plurality of parameter values of the conditional processing branch were held fixed.

5. The computer system of claim 1, wherein a first number of floating point operations associated with processing of all of the input tokens with the conditional processing branch is greater than a second number of floating point operations associated with processing of all of the input tokens with the adapter processing branch.

6. The computer system of claim 1, wherein the conditional processing branch comprises a transformer layer and the adapter processing branch comprises a feed-forward layer.

7. The computer system of claim 1, wherein the router sublayer is configured to select a top-k number of the input tokens for processing with the conditional processing branch based on the plurality of routing values.

8. The computer system of claim 1, wherein the plurality of routing values comprises a one-hot vector of binary values.

9. The computer system of claim 1, wherein the router sublayer is configured to:
apply the plurality of learned parameter values to the plurality of input tokens of the first layer to generate a plurality of selection weights respectively for the plurality of input tokens; and
determine the plurality of routing values for the plurality of input tokens based on the plurality of selection weights.

10. The computer system of claim 9, wherein the router sublayer is further configured to:
generate a set of masked tokens based on the plurality of routing values, wherein tokens that are not included in the subset are masked to have a value of zero; and
project the set of masked tokens into a reduced shape that does not include zero-valued tokens.

11. The computer system of claim 10, wherein the conditional processing layer is configured to perform k-to-k attention in which the set of masked tokens are used as both query vectors and key-value vectors.

12. The computer system of claim 10, wherein the conditional processing layer is configured to perform k-to-all attention in which the set of masked tokens are used as query vectors and all of the input tokens are used as key-value vectors.

13. The computer system of claim 9, wherein the first layer is configured to generate a layer output that comprises the plurality of input tokens summed with an output of the adapter processing branch summed with an output of the conditional processing branch that has been scaled according to the plurality of selection weights.

14. The computer system of claim 9, wherein to determine the plurality of routing values for the plurality of input tokens based on the plurality of selection weights the router sublayer is configured to perform a soft top-k operator on the plurality of selection weights.

15. The computer system of claim 1, wherein:
the model input comprises a natural language input and the model output comprises an output for a natural language processing task;
the model input comprises an image input and the model output comprises an output for an image processing task; or
the model input comprises a speech input and the model output comprises an output for a speech processing task.

16. A computer-implemented method to perform parameter-efficient transfer learning with fast inference, the method comprising:
obtaining, by a computing system comprising one or more computing devices, a pre-trained machine-learned model having a plurality of layers;
modifying, by the computing system, at least a first layer of the plurality of layers to add:
an adapter processing branch in parallel to an existing processing branch of the first layer; and
a router sublayer comprising a plurality of parameter values, wherein the router sublayer is configured to:
apply the plurality of parameter values to a plurality of input tokens of the first layer to generate a plurality of routing values respectively for the plurality of input tokens; and
select a subset of the plurality of input tokens for processing with the existing processing branch based on the plurality of routing values; and
training, by the computing system, the machine-learned model to learn at least the plurality of parameter values of the router sublayer.

17. The computer-implemented method of claim 16, wherein the method comprises holding, by the computing system, a second plurality of parameter values of the existing processing branch fixed while training, by the computing system, the machine-learned model to learn at least the plurality of parameter values of the router sublayer.

18. The computer-implemented method of claim 16, wherein training, by the computing system, the machine-learned model to learn at least the plurality of parameter values of the router sublayer comprises training, by the computing system, the machine-learned model to learn the plurality of parameter values of the router sublayer and further to learn a third plurality of parameter values of the adapter processing branch.

19. The computer-implemented method of claim 16, wherein training, by the computing system, the machine-learned model to learn at least the plurality of parameter values of the router sublayer comprises:
performing, by the computer system, an additional pre-training stage to learn at least the plurality of parameter values of the router sublayer; and
after the additional pre-training stage, performing, by the computer system, a fine-tuning stage to further learn at least the plurality of parameter values of the router sublayer.

20. One or more or more non-transitory computer-readable media that collectively store:
a machine-learned conditional adapter model configured to receive and process a model input to generate a model output, wherein the machine-learned conditional adapter model comprises one or more layers, and wherein at least a first layer of the one or more layers comprises:
a conditional processing branch;
an adapter processing branch in parallel to the conditional processing branch; and
a router sublayer comprising a plurality of learned parameter values, wherein the router sublayer is configured to:
apply the plurality of learned parameter values to a plurality of input tokens of the first layer to generate a plurality of routing values respectively for the plurality of input tokens; and
select a subset of the plurality of input tokens for processing with the conditional processing branch based on the plurality of routing values.
